(19) United States
(12) Patent Application Publication
(10) Pub. No.: US 2018/0268311 A1
(43) Pub. Date: Sep. 20, 2018

(54) PLAUSIBILITY-BASED AUTHORIZATION

(71) Applicant: Microsoft Technology Licensing, LLC, Redmond, WA (US)

(72) Inventor: Clemens Vasters, Viersen (DE)

(21) Appl. No.: 15/458,916

(22) Filed: Mar. 14, 2017

(51) Int. Cl. G06N 5/04; G06N 99/00

(52) U.S. Cl. CPC G06N 5/047; G06N 99/005

(57) ABSTRACT

The disclosed technology is generally directed to data corroboration, e.g., in IoT systems. In one example of the technology, receiving a first set of data over time from a first external device. A plausibility of the first set of data is determined based upon behavioral pattern matching. The first set of data is selectively authorizing as valid based at least upon the plausibility determination.

### BACKGROUND

The Internet of Things (“IoT”) generally refers to a system of devices capable of communicating over a network. The devices can include everyday objects such as toasters, coffee machines, thermostat systems, washers, dryers, lamps, automobiles, and the like. The devices can also include sensors in buildings and factory machines, sensors and actuators in remote industrial systems, and the like. The network communications can be used for device automation, data capture, providing alerts, personalization of settings, and numerous other applications.

### SUMMARY OF THE DISCLOSURE

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Briefly stated, the disclosed technology is generally directed to data corroboration, e.g., in IoT systems. In one example of the technology, a first set of data is received over time from a first external device. A plausibility of the first set of data may be determined based upon behavioral pattern matching. The first set of data may be selectively authorized as valid based at least upon the plausibility determination.

In examples of the disclosure, devices may used as beacons to indicate their spatial trajectory over time, where the device may be associated with a person, animal, vehicle, or the like. The environment may also have one or more external devices that track the spatial trajectories of beacons in a particular area. A user may have an active device that reads the spatial trajectory data from the beacons. The active device may include a mechanism for determining the validity of the data, and possibly also the source of the spatial trajectory (e.g., whether the spatial trajectory is being generated by a person, animal, vehicle, or the like.) The plausibility of the spatial trajectory may be determined based on behavioral pattern matching, and in some contexts, based on behavioral pattern matching, and the source of the spatial trajectory may also be determined. Based on the plausibility assessment, the device may determine how likely the data is to be valid.

Other aspects of and applications for the disclosed technology will be appreciated upon reading and understanding the attached figures and description.

### BRIEF DESCRIPTION OF THE DRAWINGS

Non-limiting and non-exhaustive examples of the present disclosure are described with reference to the following drawings. In the drawings, like reference numerals refer to like parts throughout the various figures unless otherwise specified. These drawings are not necessarily drawn to scale.

For a better understanding of the present disclosure, reference will be made to the following Detailed Description, which is to be read in association with the accompanying drawings, in which:

FIG. 1 is a block diagram illustrating one example of a suitable environment in which aspects of the technology may be employed;

FIG. 2 is a block diagram illustrating one example of a suitable computing device according to aspects of the disclosed technology;

FIG. 3 is a block diagram illustrating an example of a system for plausibility-based authorization; and

FIG. 4 is a diagram illustrating an example dataflow for a process for for plausibility-based authorization, in accordance with aspects of the present disclosure.

### DETAILED DESCRIPTION

The following description provides specific details for a thorough understanding of, and enabling description for, various examples of the technology. One skilled in the art will understand that the technology may be practiced without many of these details. In some instances, well-known structures and functions have not been shown or described in detail to avoid unnecessarily obscuring the description of examples of the technology. It is intended that the terminology used in this disclosure be interpreted in its broadest reasonable manner, even though it is being used in conjunction with a detailed description of certain examples of the technology. Although certain terms may be emphasized below, any terminology intended to be interpreted in any restricted manner will be overtly and specifically defined as such in this Detailed Description section. Throughout the specification and claims, the following terms take at least the meanings explicitly associated herein, unless the context dictates otherwise. The meanings identified below do not necessarily limit the terms, but merely provide illustrative examples for the terms. For example, each of the terms “based on” and “based upon” is not exclusive, and is equivalent to the term “based, at least in part, on”, and includes the option of being based on additional factors, some of which may not be described herein. As another example, the term “via” is not exclusive, and is equivalent to the term “via, at least in part”, and includes the option of being via additional factors, some of which may not be described herein. The meaning of “in” includes “in” and “on.” The phrase “in one embodiment,” or “in one example,” as used herein does not necessarily refer to the same embodiment or example, although it may. Use of particular textual numeric designators does not imply the existence of lesser-valued numerical designators. For example, reciting “a widget selected from the group consisting of a third foo and a fourth bar” would not itself imply that there are at least three foo, nor that there are at least four bar, elements. References in the singular are made merely for clarity of reading and include plural references unless plural references are specifically excluded. The term “or” is an inclusive “or” operator unless specifically indicated otherwise. For example, the phrases “A or B” means “A, B, or A and B.” As used herein, the terms “component” and “system” are intended to encompass hardware, software, or various combinations of hardware and software. Thus, for example, a system or component may be a process, a process executing on a computing device, the computing device, or a portion thereof. IoT data refers to data collected by and/or stored in IoT devices, including telemetry data and other types of data.

Briefly stated, the disclosed technology is generally directed to data corroboration, e.g., in IoT systems. In one example of the technology, a first set of data is received over time from a first external device. A plausibility of the first set of data may be determined based upon behavioral pattern matching. The first set of data may be selectively authorized as valid based at least upon the plausibility determination.

In examples of the disclosure, devices may be used as beacons to indicate their spatial trajectory over time, where the device may be associated with a person, animal, vehicle, or the like. The environment may also have one or more external devices that track the spatial trajectories of beacons in a particular area. A user may have a device that reads the spatial trajectory data from the beacons. In some examples, the user's device is an IoT device. The user's device may include a mechanism for determining the validity of the data, and possibly also the source of the spatial trajectory (e.g., whether the spatial trajectory is being generated by a person, animal, vehicle, or the like.)

The plausibility of the spatial trajectory may be determined based on behavioral pattern matching, and, in some contexts, based on behavioral pattern matching, the source of the spatial trajectory may also be determined. Based on the plausibility determination, the device may determine how likely the data is to be valid. For example, beacons could be worn by pedestrians, and this mechanism could allow vehicles to reliably detect the presence of pedestrians wearing such beacons, even when the pedestrians are not in line of sight.

Examples of the disclosure may be used in other contexts than spatial trajectory data. For instance, examples of the disclosure may be used in various contexts in which telemetry data or the like is being collected over time, for instance by an IoT device, and the IoT device may determine the likelihood of validity of the data based on the plausibility of the behavior of the data over time.

### Illustrative Devices/Operating Environments

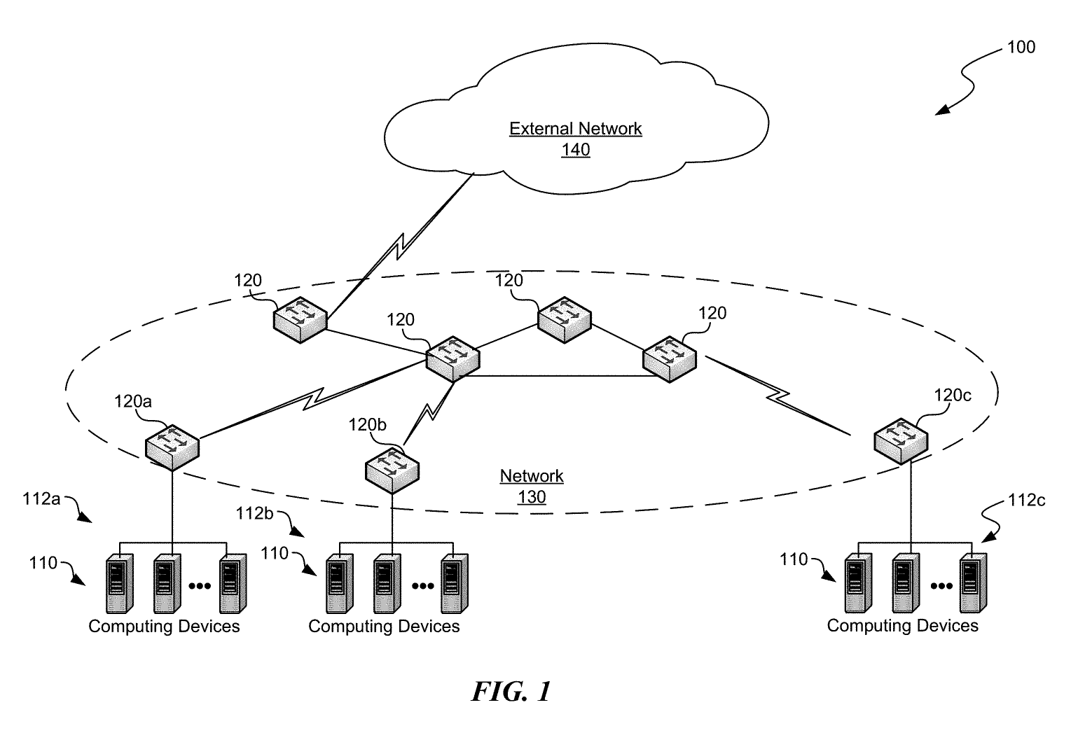

FIG. 1 is a diagram of environment 100 in which aspects of the technology may be practiced. As shown, environment 100 includes computing devices 110, as well as network nodes 120, connected via network 130. Even though particular components of environment 100 are shown in FIG. 1, in other examples, environment 100 can also include additional and/or different components. For example, in certain examples, the environment 100 can also include network storage devices, maintenance managers, and/or other suitable components (not shown). Computing devices 110 shown in FIG. 1 may be in various locations, including on premise, in the cloud, or the like. For example, computer devices 110 may be on the client side, on the server side, or the like.

As shown in FIG. 1, network 130 can include one or more network nodes 120 that interconnect multiple computing devices 110, and connect computing devices 110 to external network 140, e.g., the Internet or an intranet. For example, network nodes 120 may include switches, routers, hubs, network controllers, or other network elements. In certain examples, computing devices 110 can be organized into racks, action zones, groups, sets, or other suitable divisions. For example, in the illustrated example, computing devices 110 are grouped into three host sets identified individually as first, second, and third host sets 112a-112c. In the illustrated example, each of host sets 112a-112c is operatively coupled to a corresponding network node 120a-120c, respectively, which are commonly referred to as “top-of-rack” or “TOR” network nodes. TOR network nodes 120a-120c can then be operatively coupled to additional network nodes 120 to form a computer network in a hierarchical, flat, mesh, or other suitable types of topology that allows communications between computing devices 110 and external network 140. In other examples, multiple host sets 112a-112c may share a single network node 120. Computing devices 110 may be virtually any type of general- or specific-purpose computing device. For example, these computing devices may be user devices such as desktop computers, laptop computers, tablet computers, display devices, cameras, printers, or smartphones. However, in a data center environment, these computing devices may be server devices such as application server computers, virtual computing host computers, or file server computers. Moreover, computing devices 110 may be individually configured to provide computing, storage, and/or other suitable computing services.

In some examples, one or more of the computing devices 110 is an IoT device, an acting device, a device that comprises part or all of an IoT support service, a device comprising part or all of a device portal service, a corroborating device, or the like, as discussed in greater detail below.

### Illustrative Computing Device

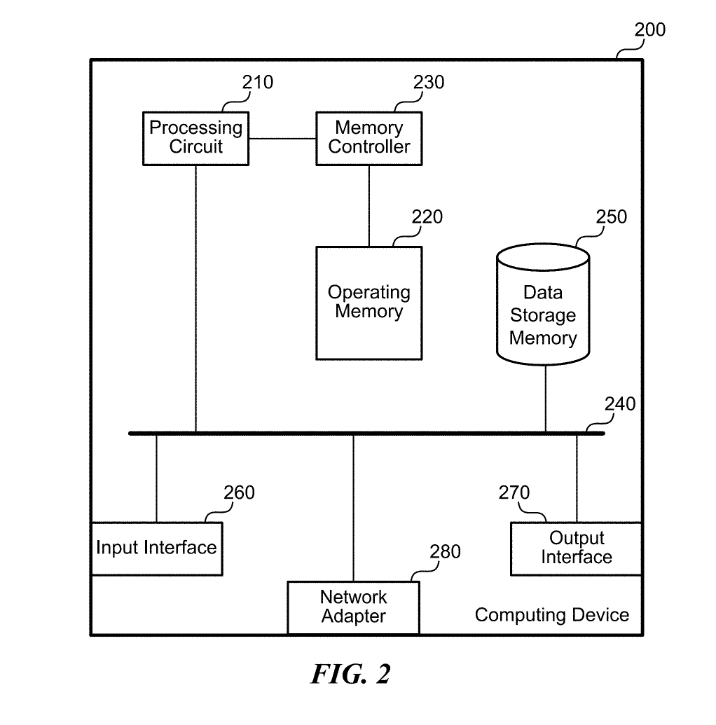

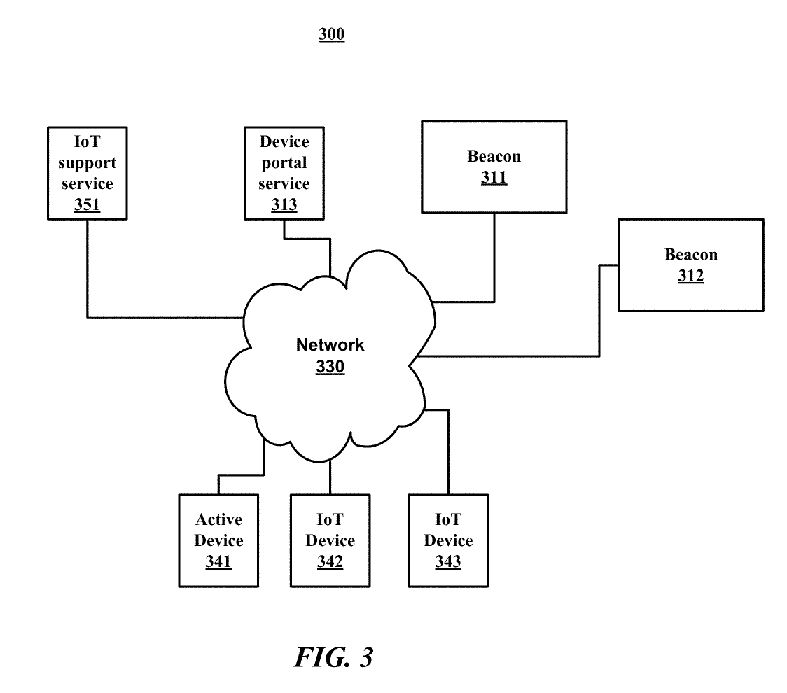

FIG. 2 is a diagram illustrating one example of computing device 200 in which aspects of the technology may be practiced. Computing device 200 may be virtually any type of general- or specific-purpose computing device. For example, computing device 200 may be a user device such as a desktop computer, a laptop computer, a tablet computer, a display device, a camera, a printer, embedded device, programmable logic controller (PLC), or a smartphone. Likewise, computing device 200 may also be server device such as an application server computer, a virtual computing host computer, or a file server computer, e.g., computing device 200 may be an example of computing device 110 or network node 120 of FIG. 1. Computing device 200 may also be an IoT device that connects to a network to receive IoT services. Likewise, computer device 200 may be an example any of the devices illustrated in or referred to in FIGS. 3 and/or 4, as discussed in greater detail below. As illustrated in FIG. 2, computing device 200 includes processing circuit 210, operating memory 220, memory controller 230, data storage memory 250, input interface 260, output interface 270, and network adapter 280. Each of these afore-listed components of computing device 200 includes at least one hardware element.

Computing device 200 includes at least one processing circuit 210 configured to execute instructions, such as instructions for implementing the herein-described workloads, processes, or technology. Processing circuit 210 may include a microprocessor, a microcontroller, a graphics processor, a coprocessor, a field-programmable gate array, a programmable logic device, a signal processor, or any other circuit suitable for processing data. The aforementioned instructions, along with other data (e.g., datasets, metadata, operating system instructions, etc.), may be stored in operating memory 220 during run-time of computing device 200. Operating memory 220 may also include any of a variety of data storage devices/components, such as volatile memories, semi-volatile memories, random access memories, static memories, caches, buffers, or other media used to store run-time information. In one example, operating memory 220 does not retain information when computing device 200 is powered off. Rather, computing device 200 may be configured to transfer instructions from a non-volatile data storage component (e.g., data storage component 250) to operating memory 220 as part of a booting or other loading process.

Operating memory 220 may include 4^{th} generation double data rate (DDR4) memory, 3^{rd} generation double data rate (DDR3) memory, other dynamic random access memory (DRAM), High Bandwidth Memory (HBM), Hybrid Memory Cube memory, 3D-stacked memory, static random access memory (SRAM), or other memory, and such memory may comprise one or more memory circuits integrated onto a DIMM, SIMM, SODIMM, or other packaging. Such operating memory modules or devices may be organized according to channels, ranks, and banks. For example, operating memory devices may be coupled to processing circuit 210 via memory controller 230 in channels. One example of computing device 200 may include one or two DIMMs per channel, with one or two ranks per channel. Operating memory within a rank may operate with a shared clock, and shared address and command bus. Also, an operating memory device may be organized into several banks where a bank can be thought of as an array addressed by row and column. Based on such an organization of operating memory, physical addresses within the operating memory may be referred to by a tuple of channel, rank, bank, row, and column.

Despite the above-discussion, operating memory 220 specifically does not include or encompass communications media, any communications medium, or any signals per se.

Memory controller 230 is configured to interface processing circuit 210 to operating memory 220. For example, memory controller 230 may be configured to interface commands, addresses, and data between operating memory 220 and processing circuit 210. Memory controller 230 may also be configured to abstract or otherwise manage certain aspects of memory management from or for processing circuit 210. Although memory controller 230 is illustrated as single memory controller separate from processing circuit 210, in other examples, multiple memory controllers may be employed, memory controller(s) may be integrated with operating memory 220, or the like. Further, memory controller(s) may be integrated into processing circuit 210. These and other variations are possible.

In computing device 200, data storage memory 250, input interface 260, output interface 270, and network adapter 280 are interfaced to processing circuit 210 by bus 240. Although, FIG. 2 illustrates bus 240 as a single passive bus, other configurations, such as a collection of buses, a collection of point to point links, an input/output controller, a bridge, other interface circuitry, or any collection thereof may also be suitably employed for interfacing data storage memory 250, input interface 260, output interface 270, or network adapter 280 to processing circuit 210.

In computing device 200, data storage memory 250 is employed for long-term non-volatile data storage. Data storage memory 250 may include any of a variety of non-volatile data storage devices/components, such as non-volatile memories, disks, disk drives, hard drives, solid-state drives, or any other media that can be used for the non-volatile storage of information. However, data storage memory 250 specifically does not include or encompass communications media, any communications medium, or any signals per se. In contrast to operating memory 220, data storage memory 250 is employed by computing device 200 for non-volatile long-term data storage, instead of for run-time data storage.

Also, computing device 200 may include or be coupled to any type of processor-readable media such as processor-readable storage media (e.g., operating memory 220 and data storage memory 250) and communication media (e.g., communication signals and radio waves). While the term processor-readable storage media includes operating memory 220 and data storage memory 250, the term “processor-readable storage media,” throughout the specification and the claims whether used in the singular or the plural, is defined herein so that the term “processor-readable storage media” specifically excludes and does not encompass communications media, any communications medium, or any signals per se. However, the term “processor-readable storage media” does encompass processor cache, Random Access Memory (RAM), register memory, and/or the like.

Computing device 200 also includes input interface 260, which may be configured to enable computing device 200 to receive input from users or from other devices. In addition, computing device 200 includes output interface 270, which may be configured to provide output from computing device 200. In one example, output interface 270 includes a frame buffer, graphics processor, graphics processor or accelerator, and is configured to render displays for presentation on a separate visual display device (such as a monitor, projector, virtual computing client computer, etc.). In another example, output interface 270 includes a visual display device and is configured to render and present displays for viewing.

In the illustrated example, computing device 200 is configured to communicate with other computing devices or entities via network adapter 280. Network adapter 280 may include a wired network adapter, e.g., an Ethernet adapter, a Token Ring adapter, or a Digital Subscriber Line (DSL) adapter. Network adapter 280 may also include a wireless network adapter, for example, a Wi-Fi adapter, a Bluetooth adapter, a ZigBee adapter, a Long Term Evolution (LTE) adapter, or a 5G adapter.

Although computing device 200 is illustrated with certain components configured in a particular arrangement, these components and arrangements are merely one example of a computing device in which the technology may be employed. In other examples, data storage memory 250, input interface 260, output interface 270, or network adapter 280 may be directly coupled to processing circuit 210, or be coupled to processing circuit 210 via an input/output controller, a bridge, or other interface circuitry. Other variations of the technology are possible.

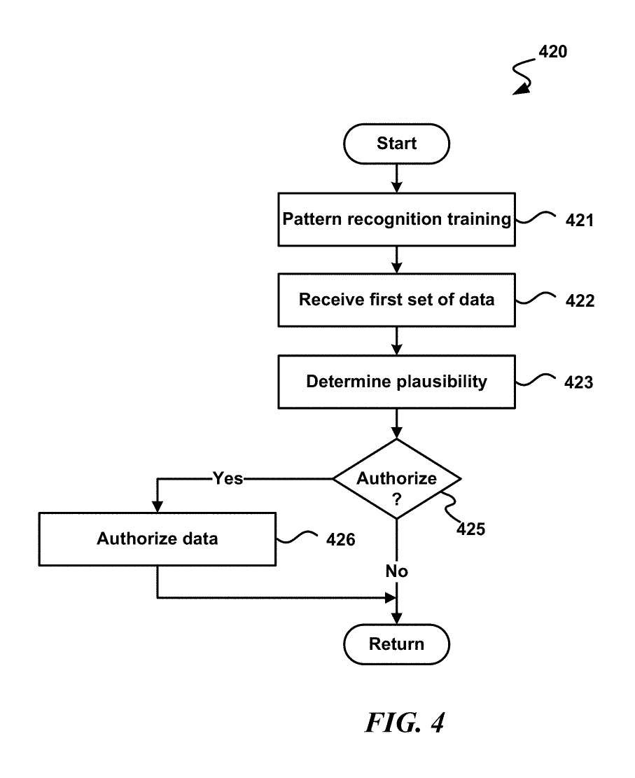

Some examples of computing device 200 include at least one memory (e.g., operating memory 220) adapted to store run-time data and at least one processor (e.g., processing unit 210) that is respectively adapted to execute processor-executable code that, in response to execution, enables computing device 200 to perform actions. In some examples, computing device 200 is enabled to perform actions such as the actions in the process of FIG. 4, or actions in a process performed by one or more of the computing devices in FIG. 3 below.

### Illustrative Systems

FIG. 3 is a block diagram illustrating an example of a system (300) for plausibility-based authorization. System 300 may include network 330, IoT support service 351, active device 341, IoT devices 342 and 343, beacons 311 and 312, and device portal service 313, which all connect to network 330. Device portal service 313 may include one or more devices that provide a device portal. In some examples, contrary to what is literally shown in FIG. 3, some or all of the communication is performed by non-network means. For instance, in some examples, beacons 311 and 312 are radio beacons that provide electromagnetic signals received through the air by various devices including, for example, active device 341.

The term “IoT device” refers to a device intended to make use of IoT services. An IoT device can include virtually any device that connects to a network to use IoT services, including for telemetry collection or any other purpose. IoT devices include any devices that can connect to a network to make use of IoT services. In various examples, IoT devices may communicate with a cloud, with peers or local system or a combination or peers and local systems and the cloud, or in any other suitable manner. IoT devices can include everyday objects such as toasters, coffee machines, thermostat systems, washers, dryers, lamps, automobiles, and the like. IoT devices may also include, for example, a variety of devices in a “smart” building including lights, temperature sensors, humidity sensors, occupancy sensors, and the like. The IoT services for the IoT devices can be used for device automation, data capture, providing alerts, personalization of settings, and numerous other applications.

The term “IoT support service” refers to a device, a portion of at least one device, or multiple devices such as a distributed system, to which, in some examples, IoT devices connect on the network for IoT services. In some examples, the IoT support service is an IoT hub. In some examples, the IoT hub is excluded, and IoT devices communicate with an application back-end, directly or through one or more intermediaries, without including an IoT hub, and a software component in the application back-end operates as the IoT support service. IoT devices may receive IoT services via communication with the IoT support service. In some examples, an IoT support service may be embedded inside of a device, or in local infrastructure.

Active device 341 may be virtually any device that receives data from one or more other devices and determines the validity of the received data. In some examples, active device 341 is an IoT device. In other examples, active device 341 is not an IoT device.

Each of the IoT devices 342 and 343, active device 341, and/or the devices that comprise IoT support service 351 and/or device portal service 313 may include examples of computing device 200 of FIG. 2. The term “IoT support service” is not limited to one particular type of IoT service, but refers to the device to which the IoT device communicates, after provisioning, for at least one IoT solution or IoT service. That is, the term “IoT support service,” as used throughout the specification and the claims, is generic to any IoT solution. The term IoT support service simply refers to the portion of the IoT solution/IoT service to which provisioned IoT devices communicate. In some examples, communication between IoT devices and one or more application back-ends occur with an IoT support service as an intermediary. FIG. 3 and the corresponding description of FIG. 3 in the specification illustrates an example system for illustrative purposes that does not limit the scope of the disclosure.

In some examples, beacon 311 is an amulet or wristband or the like that operates as a beacon that provides data, such as a signal as a digital accelerometer reading, other suitable provided signal over time, or the like. Some examples of beacon 311 are “nomadic” devices.

In some examples, IoT devices 342 and 343 provide telemetry and/or environmental data that may be used by one or more of the other IoT devices and/or active device 341 while performing various functions.

Network 330 may include one or more computer networks, including wired and/or wireless networks, where each network may be, for example, a wireless network, local area network (LAN), a wide-area network (WAN), and/or a global network such as the Internet. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. Network 330 may include various other networks such as one or more networks using local network protocols such as 6LoWPAN, ZigBee, or the like. Some IoT devices may be connected to a user device via a different network in network 330 than other IoT devices. In essence, network 330 includes any communication method by which information may travel between IoT support service 351, IoT devices 341-343, beacons 311 and 312, and device portal service 313. Although each device or service is shown connected as connected to network 330, that does not mean that each device communicates with each other device shown. In some examples, some devices/services shown only communicate with some other devices/services shown via one or more intermediary devices. Also, although network 330 is illustrated as one network, in some examples, network 330 may instead include multiple networks that may or may not be connected with each other, with some of the devices shown communicating with each other through one network of the multiple networks and other of the devices shown communicating with each other with a different network of the multiple networks.

As one example, IoT devices 342 and 343 are devices that are intended to make use of IoT services provided by the IoT support service, which, in some examples, includes one or more IoT support services, such as IoT support service 351. Device portal service 313 may include a device or multiple devices that perform actions in providing a device portal to users of IoT devices.

Device portal service 313 is a service which may be used by users of IoT devices to manage IoT services for IoT devices including IoT device 342 and IoT device 343.

In some examples, beacons 311 and 312 communicate via network 330. In other examples, beacons 311 provide signals through the air that are received by other devices, such as, in some examples, active device 341. In some examples, each device shown in FIG. 3 except for active device 341 is external to active device 341.

System 300 may include more or less devices than illustrated in FIG. 3, which is shown by way of example only.

### Illustrative Processes

For clarity, the processes described herein are described in terms of operations performed in particular sequences by particular devices or components of a system. However, it is noted that other processes are not limited to the stated sequences, devices, or components. For example, certain acts may be performed in different sequences, in parallel, omitted, or may be supplemented by additional acts or features, whether or not such sequences, parallelisms, acts, or features are described herein. Likewise, any of the technology described in this disclosure may be incorporated into the described processes or other processes, whether or not that technology is specifically described in conjunction with a process. The disclosed processes may also be performed on or by other devices, components, or systems, whether or not such devices, components, or systems are described herein. These processes may also be embodied in a variety of ways. For example, they may be embodied on an article of manufacture, e.g., as processor-readable instructions stored in a processor-readable storage medium or be performed as a computer-implemented process. As an alternate example, these processes may be encoded as processor-executable instructions and transmitted via a communications medium.

FIG. 4 is a diagram illustrating an example dataflow for a process (420) for IoT device permissioning. FIG. 4 and the corresponding description of FIG. 4 in the specification illustrate an example process for illustrative purposes that do not limit the scope of the disclosure. In some examples, the process of FIG. 4 is performed by a device, such as active device 441 of FIG. 4, or another suitable device. The device performing process of FIG. 4 is referred to as the “active device” herein. While some examples of the active device being an IoT device are discussed herein, in other examples, the active device may be any suitable device that is capable of receiving data from a first external device and selectively authorizing the validity of the data received from the first external device.

There are several contexts in which the process of FIG. 4 may be employed. In some examples, the process of FIG. 4 may be used in any suitable context involving the collection of telemetry data and/or environmental data, including, among other contexts, building automation. The telemetry data may include temperature, humidity, occupancy of a location associated with the IoT device, geolocation, and/or the like. The data may be collected via software inputs, hardware inputs, or both. In this context, the process of FIG. 4 may be used in determining the validity of collected telemetry data.

The process of FIG. 4 may also be used in a context of moving people, animals, vehicles, robots, and/or other moving objects, in which spatial trajectory of one or more beacons is tracked. For example, the process of FIG. 4 may be used in an automotive context, where vehicles, pedestrians, animals, or the like may have beacons whose spatial trajectories may be tracked. In some examples, the beacons may be wearable device such as amulets, bands, and/or the like, that are configured to operate as beacons. In some examples, the spatial trajectory information includes accelerometer readings over time from the first external device.

The process of FIG. 4 may also be used in any suitable context involving nomadic devices that fulfill a purpose in a physical space and in which devices do not necessarily need to be registered in the environment, and in which the identity of some or all of the devices may not be known and may not even be relevant. This includes, for example, the automotive context, and numerous contexts in which such nomadic devices may be employed. In some of these contexts, nomadic devices may be dynamically introduced into the scope of a system or into a partition of a system.

In various contexts involving nomadic devices, the process of FIG. 4 may be particularly important in circumstances in which a pedestrian, animal, or other vehicle might not otherwise be seen until it is too late. For example, a pedestrian could be behind a vehicle or otherwise out of line of sight, but examples of the process of FIG. 4 may be used to detect the presence of the pedestrian even though the pedestrian is behind a vehicle or otherwise out of line of sight.

In one example, a car may be equipped with an “electronic braking light” that emits a radio signal about the car's deceleration to following cars. Following cars' driver assistance and active safety systems can therefore learn about acceleration and deceleration of vehicles ahead of them including those not immediately in line of sight. If a car A follows another car B, and car B suddenly changes out of the lane to evade a sharply braking car C in its lane ahead, car A can anticipate car C's presence and its braking action in spite of the line of sight (visual and radar) being blocked by car B until it has cleared the lane. Car A's active safety system can therefore either also decide to evade car C or initiate an appropriate braking action.

The process of FIG. 4 may be used to ensure that the radio signal from car C can be trusted. If it is possible to make car A believe incorrectly that there is a vehicle braking sharply ahead beyond its line of sight, the vehicle might initiate an emergency maneuver that puts the passengers and other traffic participants at risk. A similar risk exists in the pedestrian example; if car A incorrectly believe that there is a pedestrian ahead beyond its line of sight, the vehicle might initiate an emergency maneuver that puts the passengers and other traffic participants at risk. Sensor defects or other software defects may be as much of factor here are malice. There are several examples in which the data about another vehicle or a pedestrian could be invalid.

For instance, Car C may emit a signal, or the pedestrian's device may emit a signal but fail to report its deceleration correctly. Car B has line of sight and can override that reading with its onboard sensors. Car A's will stay on its trajectory trusting the emitted signal and rear-end Car C.

As another example, Car C may emit a signal indicating an emergency-style deceleration while that is factually not the case and therefore, based on false information, force cars B and C into emergency evasion maneuvers that may put them and other traffic participants at risk.

As another example, Car C may not exist, or the pedestrian may not exist. The signal may be emitted by a forged device or by an original, legitimate signal emitter that has been removed from another vehicle and that is introduced into the traffic situation by some means, including in another car or from a bridge or from the side of the street. As another example, a beacon that is intended to be worn by a pedestrian may be left in the road unattended.

In each of these examples, the process of FIG. 4 may be used to determine that data regarding the other vehicle, pedestrian, or the like is invalid.

As discussed above, there are contexts other than the automotive context for which nomadic devices are employed in which examples of the process of FIG. 4 may be used. For instance, the process of FIG. 4 may be used in the context of industrial environmental safety, including factory floor workplace safety. There may be robots, vehicles, people, or the like moving in the environment, and the environment may be difficult to see in for a variety of reasons, including dust, obstructions, or the like.

The process of FIG. 4 may also be used in any IoT context to determine which devices are defective, and to blacklist devices identified as defective. Invalid data can result from malice, but can also result from defective devices, including devices that once functioned properly but that have subsequently become defective. Examples of the process of FIG. 4 may be used to determine whether IoT data collected from IoT devices is valid, determine based on the validity determination which devices are detective/potentially defective, and blacklist any defective/potentially defective devices so that data from the such blacklisted devices is not accepted in the future. For instance, in some examples, if the data is determined to be invalid, the first external device may be blacklisted.

In the illustrated example, first, step 421 occurs. At step 421, pattern recognition training is performed for at least one type of signal based on training data that includes multiple distinct examples of the type of signal.

In some examples, the pattern recognition training may be accomplished based on machine learning according to a neural network model. For example, machine learning may be used to learn by behavior pattern matching the plausible behavior of temperature. Several distinct examples of temperature signals may be included in the training data in this example. As another example, machine learning may be used to learn by behavior pattern matching the plausible behavior of pedestrians. For example, during the machine learning, observations of pedestrian in the real world may be fed into a neural network model based on real-world observations of pedestrians. Several different signals representing the spatial trajectory of multiple distinct pedestrians may be included in the training data in some examples. Based on the machine learning, the signal may be compared over time, against one or more time-based reference signals using a behavior-based comparison, and a plausibility score may be calculated based on the comparison.

The process then proceeds to step 422. At step 422, a first set of data may be received over time from a first external device. In some examples, the first set of data is IoT data, such as telemetry data, collected over time from an IoT device. In other examples, the first set of data is spatial trajectory data collected over time from a nomadic device. For instance, the first set of data may be received from a beacon that emits a signal. In some examples, the beacon may be an amulet, wristband, or other wearable device that may emit a radio signal and be worn by a pedestrian, by a pet animal such as a dog or a cat, or the like. In some examples, the beacon may emit accelerometer readings. In some examples, the beacon does not require a battery, but may be powered by the movement of the person wearing the device. In some examples, the nomadic device may be a robot in an industrial safety application.

In some examples, the data received at block 422 is data received over time, rather than a point reading taken at only one point in time. In some examples, at step 422, a first signal is received from the first external device, where the first signal includes the first set of data.

The process then proceeds to block 423. At block 423, a plausibility of the first set of data may be determined based upon behavioral pattern matching based upon the pattern recognition training. In some examples, this plausibility determination is a determination as to whether the first set of data, which is related to one or more signals, is plausible, or whether instead the first set of data is implausible, e.g., as a result of a defect, malice, or some or other reason.

For example, based the pattern recognition training accomplished via machine learning, the signal may be compared over time, against one or more time-based reference signals using a behavior-based comparison, and a plausibility score may be calculated based on the comparison.

For example, in the case of telemetry data, a determination can be made as to whether the received telemetry data received over time plausibly represents the behavior of the telemetry data of the type being collected. In the case of a signal from a beacon to be worn by pedestrians, a determination can be made as to whether the spatial trajectory data of the beacon plausibly represents the behavior of a pedestrian. In other examples, a determination can be made as to whether the spatial trajectory data of the beacon plausibly represents the behavior of an animal such as a dog or a cat.

For example, in the case of temperature, a temperature sensor could potentially be fooled by lighting a match next to the temperature sensor. In one example, this would be detected as an implausible signal, because it is implausible for the temperature to rise so quickly. As another example, the actual temperature detector output could be maliciously replaced with a false signal, indicating that the temperature remains at exactly 80.0 degrees. In some examples, this would be detected as an implausible signal, because, as would be determined by machine learning, temperature over time behaves such that the temperature would have slight variations over time rather than remaining at exactly 80.0 degrees.

Based on the machine learning, a plausibility score may be generated based on the plausibility of the behavior indicated by the signal by using pattern matching to compare the signal to reference streams and/or a reference model. The plausibility score may be an indication of the trustworthiness of the signal. In some examples, the first set of data is determined to be plausible if the plausibility exceeds a determined plausibility threshold.

In some examples, the plausibility determination is identity-agnostic. In these examples, the plausibility determination is based on the behavior of the signal as opposed to the identity of the device generating the signal. In this way, in some examples, there is no need for device authentication or registration in order to make the plausibility determination. In several of the nomadic device contexts, nomadic devices may be dynamically introduced into the scope of a system or into a partition of a system. Those nomadic devices may want perform functions within such a scope without that scope having a firm understanding of the device's identity. As a consequence, the authorization of the device performing such functions within the scope may not solely or not at all be anchored on the device's identity. In some examples, the first external device has an unknown identity—e.g., such device may be anonymous.

For instance, in some examples, in the case of a pedestrian, the only matter of relevance is whether or not a signal from a beacon for a pedestrian indicates that an actual pedestrian is present, as determined by the behavior of the signal of the beacon over time—the identity of the particular pedestrian is not relevant. Similarly, in some examples, in the case of a vehicle in the automotive safety context, the fact that a vehicle has been built by a specific manufacturer, has some particular registration, or is driven by a particular individual is immaterial to establishing trust in a traffic situations. In some examples, all that matters is the concrete behavior of the vehicle on the street and establishing the fact that the car is plausibly behaving as it indicated by its signal. In some examples, what matters instead is the acting device establishing trust in the vehicle being present in the real world and that the vehicle is not providing false information about its actual behavior.

The process then proceeds to decision block 425. At decision block 425, in some examples, a determination is made as to whether or not to authorize the first set of data based on the plausibility determination. The data is authorized in the sense that is treated as valid data that is allowed to be used. In some examples, the determination at decision block 425 is based upon the plausibility score (e.g., whether the plausibility score meets a determined plausibility threshold). If the determination is made to not authorize the first set of data, the process moves to a return block, where other processing is resumed. If, instead it is determined at decision block 425 to authorize the first set of data, the process instead advances to block 426, where, in some examples, the first set of data is authorized. In this way, at decision block 425 and block 426, the first set of data is selectively authorized as valid based at least upon the plausibility determination. The processing then proceeds to the return block.

In some examples, an intended operation or action may be selectively admitted or authorized based on whether or not the first set of data is determined to be valid.

### CONCLUSION

While the above Detailed Description describes certain examples of the technology, and describes the best mode contemplated, no matter how detailed the above appears in text, the technology can be practiced in many ways. Details may vary in implementation, while still being encompassed by the technology described herein. As noted above, particular terminology used when describing certain features or aspects of the technology should not be taken to imply that the terminology is being redefined herein to be restricted to any specific characteristics, features, or aspects with which that terminology is associated. In general, the terms used in the following claims should not be construed to limit the technology to the specific examples disclosed herein, unless the Detailed Description explicitly defines such terms. Accordingly, the actual scope of the technology encompasses not only the disclosed examples, but also all equivalent ways of practicing or implementing the technology.

We claim:

1. An apparatus for data validation, comprising:
a device including at least one memory adapted to store run-time data for the device, and at least one processor that is adapted to execute processor-executable code that, in response to execution, enables the device to perform actions, including:
performing pattern recognition training for at least one type of signal based on training data that includes multiple distinct examples of the type of signal;
receiving a first set of data over time from a first external device;
determining a plausibility of the first set of data based upon behavioral pattern matching based on the pattern recognition training; and
selectively authorizing the first set of data as valid based at least upon the plausibility determination.

2. The apparatus of claim 1, wherein the pattern recognition training is based upon machine learning.

3. The apparatus of claim 1, wherein the first set of data is associated with a spatial trajectory over time.

4. The apparatus of claim 1, wherein the first external device is configured as a beacon.

5. The apparatus of claim 1, wherein determining the plausibility of the first set of data includes: using behavioral pattern matching to determine a plausibility score for the first set of data, and determining whether the plausibility score meets a first plausibility threshold.

6. The apparatus of claim 1, wherein the first external device has an unknown identity.

7. The apparatus of claim 1, further comprising blacklisting the first external device if the first set of data is not authorized.

8. The apparatus of claim 1, wherein the first set of data is a set of accelerometer readings over time from the first external device.

9. A method for data validation, comprising:
performing pattern recognition training for at least one type of signal based on training data that includes multiple distinct examples of the type of signal;
receiving a first signal from a first external device;
calculating, via at least one processor, a plausibility score for the first signal based on a behavior of the first signal over time based upon behavioral pattern matching based upon the pattern recognition training; and
selectively authorizing a first action based on a determined validity of the first signal based at least upon the plausibility score.

10. The method of claim 9, wherein the pattern recognition training is based upon machine learning.

11. The method of claim 9, wherein the first signal is associated with a spatial trajectory over time.

12. The method of claim 9, wherein the first external device is configured as a beacon.

13. The method of claim 9, wherein selectively authorizing the first action includes: determining whether the plausibility score meets a first plausibility threshold.

14. The method of claim 9, wherein the first external device has an unknown identity.

15. A processor-readable storage medium, having stored thereon process-executable code that, upon execution by at least one processor, enables actions, comprising:
performing pattern recognition training for at least one type of signal based on training data that includes multiple distinct examples of the type of signal;
receiving a first set of data over time from a first external device;
determining a plausibility of the first set of data based on the pattern recognition training; and
selectively authorizing the first set of data as valid based at least upon the plausibility determination.

16. The processor-readable medium of claim 15, wherein the pattern recognition training is based upon machine learning.

17. The processor-readable medium of claim 15, wherein the first set of data is associated with a spatial trajectory over time.

18. The processor-readable medium of claim 15, wherein the first external device is configured as a beacon.

19. The processor-readable medium of claim 15, wherein determining the plausibility of the first set of data includes: using behavioral pattern matching to determine a plausibility score for the first set of data, and determining whether the plausibility score meets a first plausibility threshold.

20. The processor-readable medium of claim 15, wherein the first external device has an unknown identity.
